(19) United States
(12) Patent Application Publication
(10) Pub. No.: US 2025/0138822 A1
(43) Pub. Date: May 1, 2025

(54) SYSTEMS AND METHODS FOR INSTRUCTION-SET AWARE ARITHMETIC CODING FOR EFFICIENT CODE COMPRESSION

(71) Applicant: Meta Platforms Technologies, LLC, Menlo Park, CA (US)

(72) Inventors: Reza Tusi, San Jose, CA (US); Shiyu Liu, Ann Arbor, MI (US); Anthony Mai, Menlo Park, CA (US); Vlad Fruchter, Los Altos, CA (US); Javid Jaffari, Woodinville, WA (US)

(21) Appl. No.: 18/666,540

(22) Filed: May 16, 2024

Related U.S. Application Data
(60) Provisional application No. 63/594,134, filed on Oct. 30, 2023.

(51) Int. Cl. G06F 9/30

(52) U.S. Cl. CPC G06F 9/3001

(57) ABSTRACT

A computer-implemented method may include dividing, by a computer processor, binary code into a plurality of chunks, wherein the binary code includes a plurality of instructions. The method may additionally include clustering, by the computer processor, similar chunks of the plurality of chunks. The method may also include performing, by the computer processor, compression of the binary code, the compression being tailored to one or more clusters of the similar chunks. Various other methods, systems, and computer-readable media are also disclosed.

### CROSS REFERENCE TO RELATED APPLICATION

This application claims the benefit of U.S. Provisional Application No. 63/594,134, filed Oct. 30, 2023, the disclosure of which is incorporated, in its entirety, by this reference.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 is a flow diagram of an exemplary method for instruction-set aware arithmetic coding for efficient code compression.

FIG. 2 is a system diagram illustrating an example system implementing instruction-set aware arithmetic coding for efficient code compression.

FIG. 3 is a flow diagram of an example process that may be used for instruction-set aware arithmetic coding for efficient code compression.

FIG. 4 is an illustration of exemplary augmented-reality glasses that may be used in connection with embodiments of this disclosure.

FIG. 5 is an illustration of an exemplary virtual-reality headset that may be used in connection with embodiments of this disclosure.

FIG. 6 is an illustration of an exemplary system that incorporates an eye-tracking subsystem capable of tracking a user's eye(s).

FIG. 7 is a more detailed illustration of various aspects of the eye-tracking subsystem illustrated in FIG. 6.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

The present disclosure is generally directed to instruction-set aware arithmetic coding for efficient code compression. As will be explained in greater detail below, embodiments of the present disclosure may divide binary code (e.g., that includes instructions) into a plurality of chunks, cluster similar chunks, and perform compression of the binary code (e.g., using two or more different compression techniques (e.g., a lossless compression algorithm corresponding to arithmetic coding and an additional lossless compression algorithm)) that is tailored to one or more clusters of the similar chunks.

Some implementations of the disclosed systems and methods may divide/chunk (e.g., based on length (e.g., half bytes)) the instructions and one or more symbol tables may be formulated based on the divided instructions. Additionally, statistics may be collected separately for each component (e.g., half byte) of every instruction type (e.g., category) and used to form clusters of similar chunks. Compression may be tailored per cluster by performing compression on each chunk of a cluster using two or more different compression techniques (e.g., a lossless compression algorithm corresponding to arithmetic coding and an additional lossless compression algorithm (e.g., LZ)). The compression results may be evaluated to determine the contributions of the two or more different compression techniques in performing the compression. These evaluations may be used to modify one or more of the compression techniques (e.g., more application of one technique and less application of another) in an iterative process that progressively reduces the lower bound and/or approaches the reduced lower bound. The resulting compressed code may be decoded while requiring few or no modifications to a decoder.

Bit may refer to a fundamental unit of information content and entropy may refer to a measure of an amount of uncertainty involved in the value of a random variable or outcome of a random process (e.g., probability distribution dependent). Entropy may be a weighted sum of information content (e.g., in bits) across all symbols, and it may provide a lower bound of a (e.g., average) codesize to encode a piece of information.

Different types of data compression may impact codesize. A first type of data compression adds mutual knowledge to a coding pipeline that reduces a theoretical lower bound. For example, Lempel-Ziv (LZ) compression leverages the repetition of a data sequence whereas run-length coding utilizes the fact that a same data value may occur in many consecutive data elements. In this context, LZ4 compression captures the recurrence of some code sequences and encodes them in a more compact format. At least two different types of LZ4 tokens may be used depending on the existence of matches. A second type of data compression, entropy coding, may approach the theoretical lower bound. Examples of entropy coding include Huffman coding and arithmetic coding. In this context, entropy coding may use less bits to encode literals with more frequent occurrences.

Footprint (e.g., area) of a digital signal processor (DSP) may be determined, in part, by code memory size. Progressively reducing the lower bound and/or approaching the reduced lower bound by tailoring the compression of clustered chunks using two or more different compression techniques may reduce codesize and, thus, code memory size. In this way, the code may be compressed efficiently to reduce the code memory size, reducing the footprint of the DSP that stores and executes the instructions. Reducing DSP footprint in this manner may result in improved miniaturization that may be of benefit in various devices (e.g., augmented-reality glasses and/or virtual-reality headsets) in which DSPs may be included that store and execute instructions (e.g., to capture and/or display images and/or to perform eye tracking).

Features from any of the embodiments described herein may be used in combination with one another in accordance with the general principles described herein. These and other embodiments, features, and advantages will be more fully understood upon reading the following detailed description in conjunction with the accompanying drawings and claims.

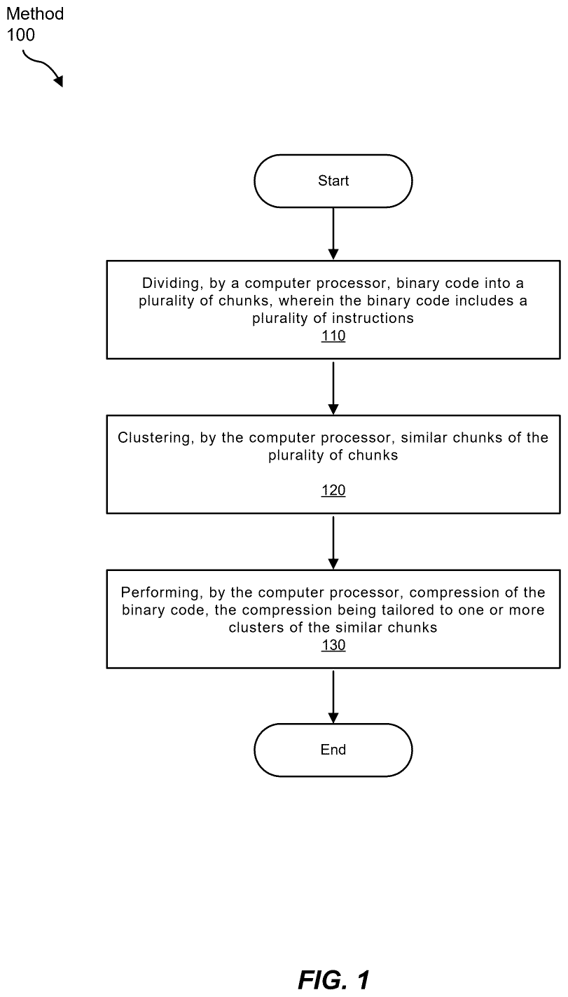

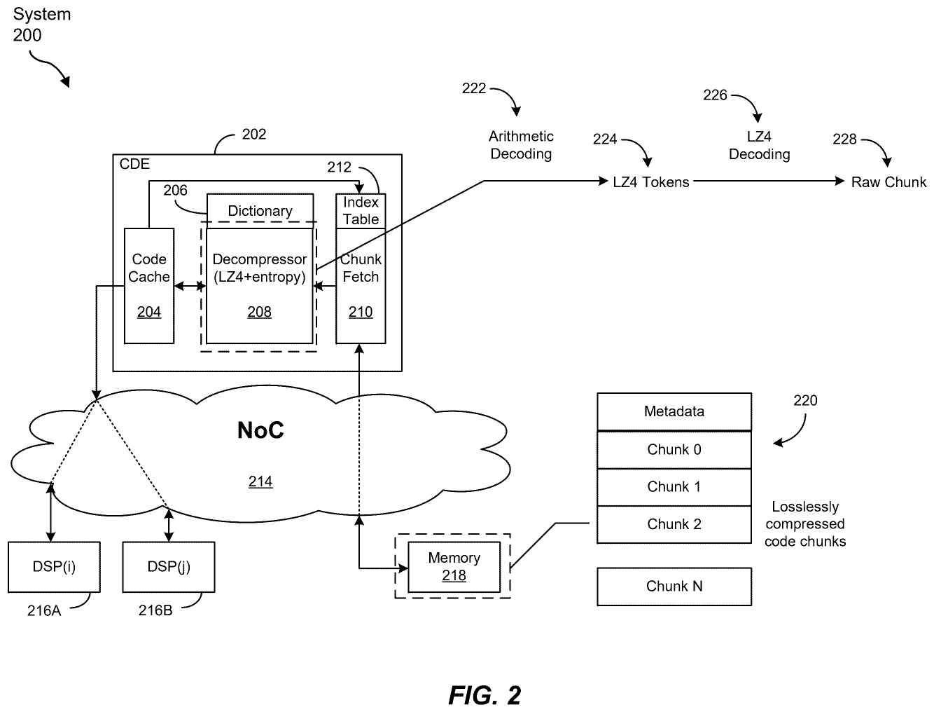

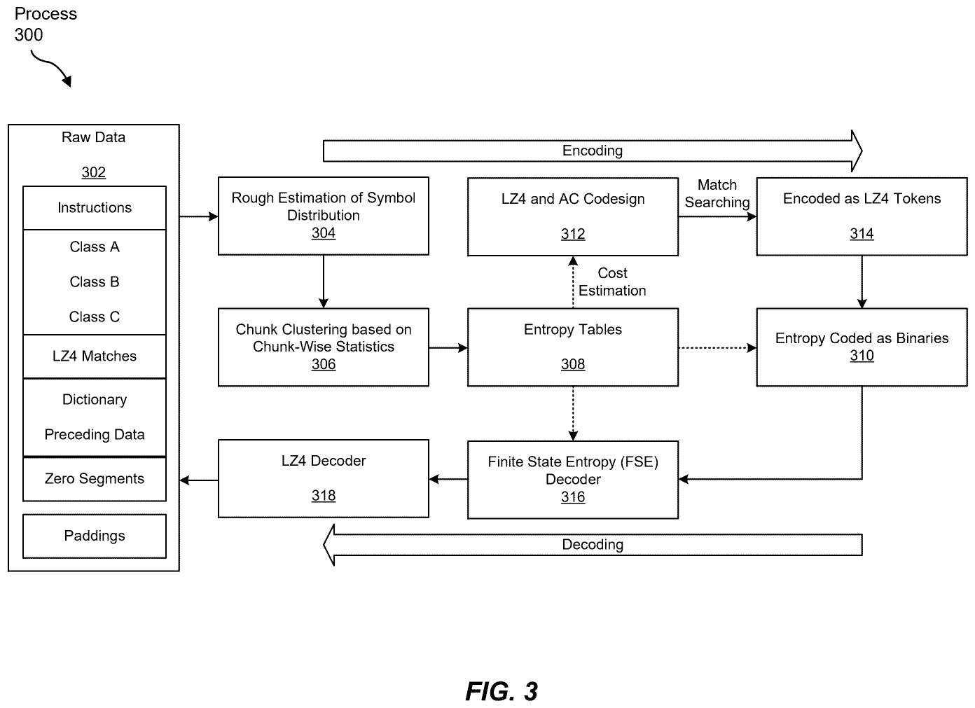

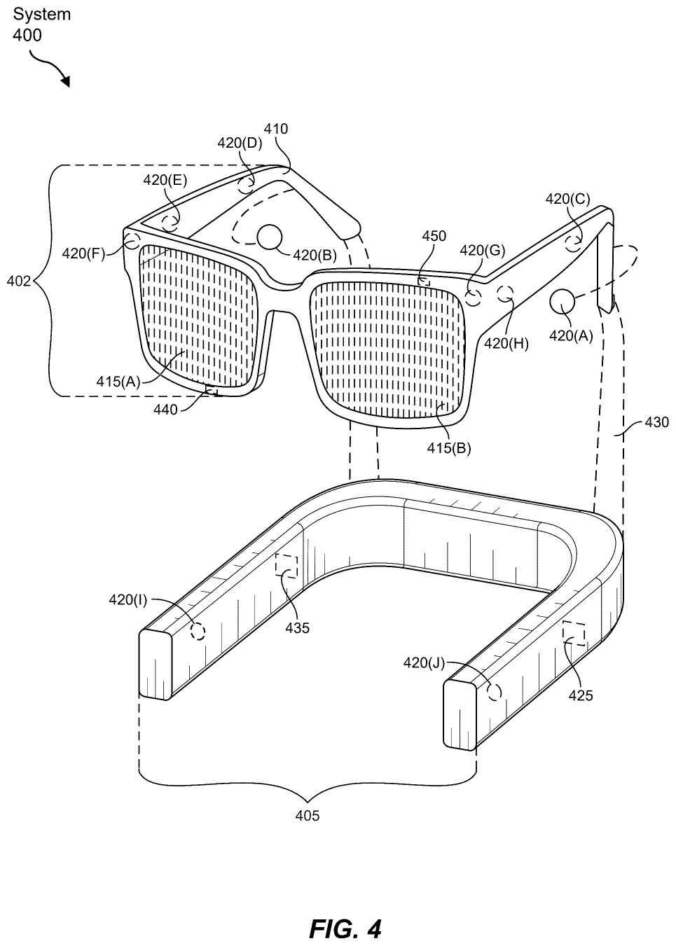

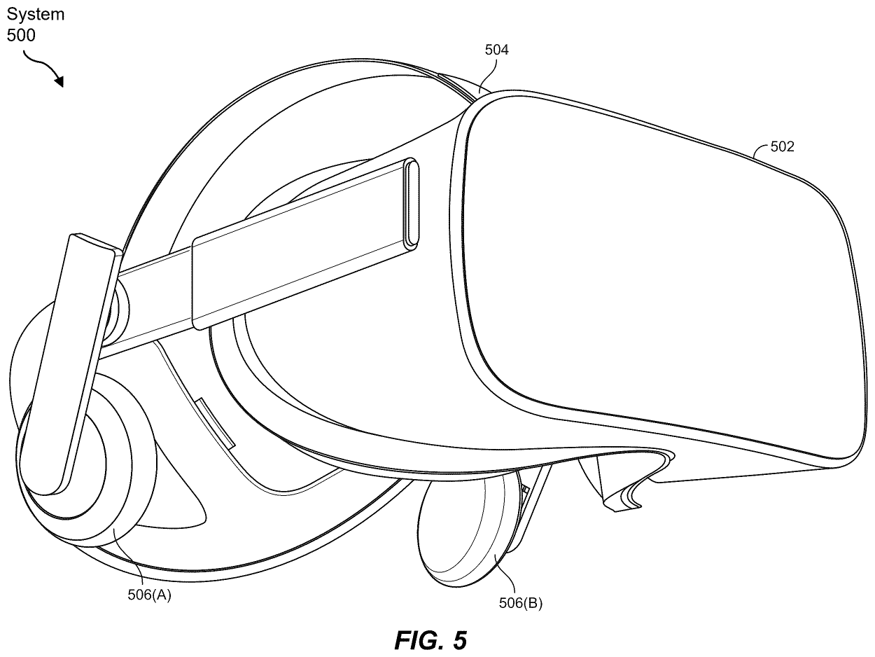

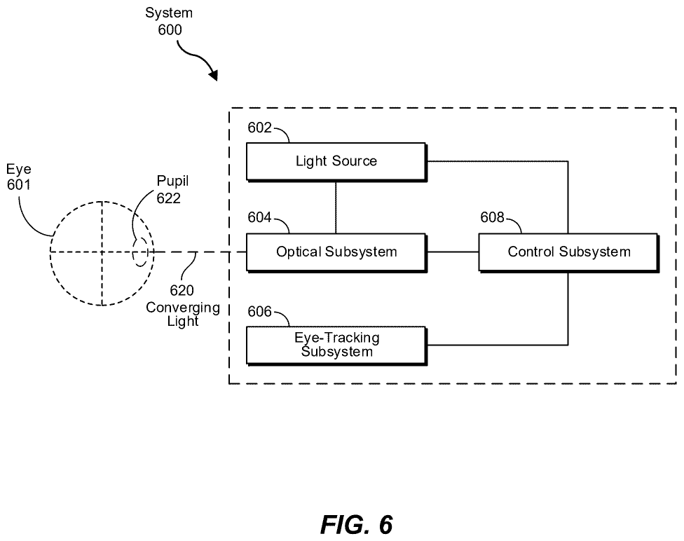

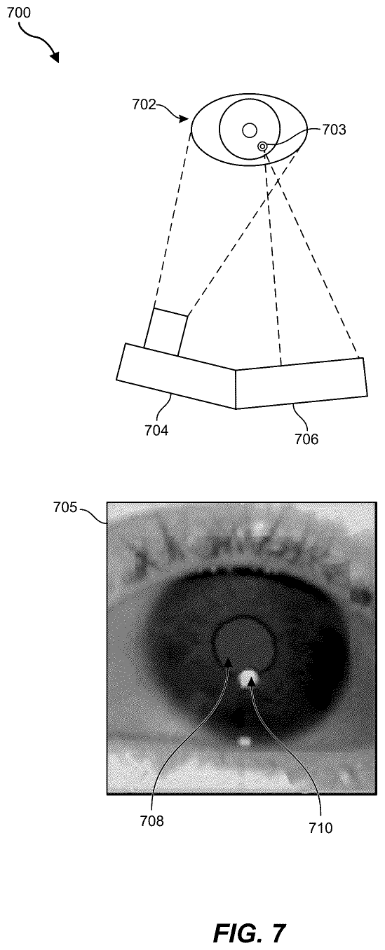

The following will provide, with reference to FIG. 1, detailed descriptions of exemplary methods for instruction-set aware arithmetic coding for efficient code compression. Detailed descriptions of example systems for instruction-set aware arithmetic coding for efficient code compression will be provided in connection with FIGS. 2 and 3. Detailed descriptions of augmented-reality (AR) and virtual-reality (VR) devices will be provided in connection with FIGS. 4 and 5. Detailed descriptions of example systems and aspects of eye-tracking subsystems will be provided in connection with FIGS. 6 and 7.

FIG. 1 is a flow diagram of an exemplary computer-implemented method 100 for instruction-set aware arithmetic coding for efficient code compression. The steps shown in FIG. 1 may be performed by any suitable computer-executable code and/or computing system, including the system(s) illustrated in FIGS. 2 and 3. In one example, each of the steps shown in FIG. 1 may represent an algorithm whose structure includes and/or is represented by multiple sub-steps, examples of which will be provided in greater detail below. In this context, a computing system may include analog circuitry, digital circuitry, or combinations thereof that are configured to perform the steps shown in FIG. 1.

As illustrated in FIG. 1, at step 110 one or more of the systems described herein may divide binary code. For example, method 100 may, at step 110, divide, by a computer processor, binary code into a plurality of chunks, wherein the binary code includes a plurality of instructions.

The term “binary code,” as used herein, may generally refer to a form of computer code. For example, and without limitation, binary code may consist of two numbers: 0 and 1. These numbers may form a basic layer of a computing system and be a primary language of digital technologies. Binary code may use combinations of these two numbers to represent numbers, letters, or other types of information.

The term “chunks,” as used herein, may generally refer to pieces of data resulting from division of the data into smaller pieces. For example, chunking may refer to a process that splits a file into smaller pieces called chunks by a chunking algorithm. Fixed-size chunking may be achieved by dividing an entire file into small blocks each having a same size.

The term “instructions,” as used herein, may generally refer to orders that are given to a computer processor by a computer program. For example, computer instructions may be communicated using binary code, a sequence of 0 s and 1 s that describe the action a computer system is expected to perform.

The systems described herein may perform step 110 in a variety of ways. In one example, step 110 may include formulating, by the computer processor, a symbol table based on the plurality of instructions. Alternatively or additionally, step 110 may include formulating the symbol table based on divided instructions included in the plurality of chunks. In some implementations, step 110 may include dividing the plurality of instructions into half-bytes.

At step 120 one or more of the systems described herein may cluster similar chunks. For example, method 100 may, at step 120, cluster, by the computer processor, similar chunks of the plurality of chunks.

The term “cluster,” as used herein, may generally refer to a grouping of objects based on similarities. For example, and without limitation, cluster analysis may group a set of objects in such a way that objects in the same group (e.g., called a cluster) are more similar (e.g., in some specific sense defined by the analyst) to each other than to those in other groups (e.g., clusters).

The systems described herein may perform step 120 in a variety of ways. In one example, step 120 may include determining chunk statistics for each chunk of the plurality of chunks and clustering chunks from the plurality of chunks into clusters based on the chunk statistics. For example, the chunk statistics may be based on variable length instruction formats, variable bit and/or byte distribution between instruction formats, one or more lossless compression algorithm matches, one or more zero segments within the binary code, and/or padding within the binary code.

At step 130 one or more of the systems described herein may perform compression. For example, method 100 may, at step 130, perform, by the computer processor, compression of the binary code, the compression being tailored to one or more clusters of the similar chunks.

The term “compression,” as used herein, may generally refer to a process of encoding information using fewer bits than an original representation. For example, and without limitation, compression may be either lossy or lossless. Lossless compression may reduce bits by identifying and eliminating statistical redundancy. No information is lost in lossless compression. Lossy compression may reduce bits by removing unnecessary or less important information. Typically, a device that performs data compression may be referred to as an encoder, and one that performs the reversal of the process (e.g., decompression) may be referred to as a decoder.

The systems described herein may perform step 130 in a variety of ways. In one example, the compression may be tailored to the one or more clusters by evaluating contributions of two or more different compression techniques in performing the compression, and iteratively tailoring the two or more different compression techniques based on the evaluation. Alternatively or additionally, the two or more different compression techniques may include a combination of a lossless compression algorithm corresponding to arithmetic coding and an additional lossless compression algorithm. In this context, the lossless compression algorithm may correspond to a Lempel-Ziv algorithm.

In the example methods 100, code compression may be performed in a manner that more efficiently compresses coded instructions. Example encoding approaches may include breaking binary code into a number of chunks, for example, based on a number of instructions in each chunk. Symbol distributions may then be estimated for each chunk and used to create a feature vector for the chunk. For example, instructions may be classified based on instruction type and/or instruction length. The chunks may then be clustered based on the feature vectors derived from the chunk statistics.

In some examples, compression (which may also be termed encoding) may use a combination of a lossless compression algorithm corresponding to arithmetic coding (AC) and, for example, an additional lossless compression algorithm such as an LZ algorithm, such as LZ4. In some examples, other lossless compression algorithms may be used.

In some examples, a combination of AC and LZ4 algorithms may be co-optimized, for example, to reduce the size of the compressed code (e.g., rather than based on match lengths).

In some examples, code may be compressed by converting LZ4 matched symbols to LZ4 tokens, with the corresponding entropy data being encoded as binary data. This approach may increase efficiency as code may be compressed once and then decompressed (i.e., decoded) on multiple occasions when needed. In some examples, the compression may be performed by one processor and the decoding may be performed on either the same processor or another processor, such as a digital signal processor.

Applications may include code transfer between different parts of a processor or between different processors. In some examples, approaches described herein may allow improved efficiency code transfer from a processor such as a central processor unit (CPU) to a hardware accelerator, for example, a digital signal processor (DSP), microcontroller-based embedded system or other hardware accelerator.

In some examples, code compression may be generally useful in any application where code is transmitted from a first location to a second location. The first location may include a processor, such as a CPU. The second location may include a second processor, such as a DSP or other hardware accelerator or other remote processor. In some examples, an executable file may be transmitted from a first processor to a second processor, and the transmitted code may be compressed before transmission using an approach such as described herein, for example, for more efficient transmission. Examples include chip-to-chip transmission as described above, and further include code transmission between different parts of the same chip (e.g., intra-chip transmission such as between two separate portions of the same processor).

Context adaptive code compression may provide improved performance compared to other existing methods when applied to binary code, other code, or other target data. The adoption of cost estimation in compression tasks allows explicit optimization objectives to be obtained. The co-design (e.g., co-optimization) technique using different (and, e.g., lossless) encoding schemes may further be applied to other compression problems as a generic method.

Code to be compressed may include binary instructions and may include multiple kinds of instructions of different instruction lengths. Instructions may be classified, for example, based on instruction parameters such as instruction type and instruction length. Symbolic distributions may be encoded as a feature vector.

FIG. 2 shows an example system 200 that may be used for code compression. The system may include a device 202 including a code cache 204, dictionary 206, decompressor 208 (which may also be termed a decoder), chunk fetcher 210, and index table 212. The device 202 may be in communication with a network 214, such as a network on a chip (NoC), through one or more buses, for example, including one or more advanced extensible interface (AXI) buses. The device 202 may provide a code decompression engine (CDE). The network 214 may be further in communication with one or more digital signal processors (DSPs) 216A and 216B, and in communication with one or more memory devices 218, for example, from which losslessly compressed code chunks 220 may be retrieved. Creation of compressed code chunks 220 is discussed in more detail below in relation to FIG. 3.

The chunk fetcher 210 may retrieve compressed code chunks 220 from the one or more memory devices 218 and provide them to the decompressor 208. Decompressor 208 may use arithmetic coding 222 to convert the compressed code chunks 220 to LZ4 tokens 224 and LZ4 decoding 226 to convert the LZ4 tokens 224 to raw chunks 228. In some examples, the chunk fetcher 210 may retrieve code chunks 220, decompress the chunks 220, and store the decompressed chunks in the code cache 204. One or more of the plurality of digital signal processors 216A and 216B may retrieve decompressed code chunks 220 as needed. In some examples, the decompressed code may be used a plurality of times by one or more digital signal processors 216A and 216B. In some examples, code may be compressed, transmitted to a different location (e.g., a second processor), decompressed, stored in memory, then retrieved on a plurality of occasions as needed.

FIG. 3 illustrates an example process 300 that may be used for instruction-set aware arithmetic coding for efficient code compression. As shown in FIG. 3, raw data 302 to be compressed may include several categories of coded instructions, such as instruction classes, zero segments, and paddings. This code to be compressed may be divided into multiple chunks and a feature vector may be associated with each chunk. In this context, a feature vector may encode features of the respective chunk. A feature vector may include distribution data for various instructions (and/or category of instruction). Such symbol distribution may be estimated at step 304. Cost estimate data may also be determined, for example, including encoding costs for one or more or each symbol.

In some examples, chunk clustering may be performed at step 306 based on overall and/or chunk statistics. Statistics may be used to form entropy tables 308. This may complicate the encoding process but does not introduce delays into decoding. In some examples, a rough estimate of encoding cost may be determined from the feature vectors. For example, a cost estimate may be determined for code compression. In some examples, cluster instructions may be based on very long instruction word (VLIW) instructions. Chunk clustering may include creation of non-uniform binaries.

In some examples, a separate entropy table 308 may be created for each chunk. An entropy table 308 may be created based on statistics for each detected instruction. In some examples, a distribution and an entropy table 308 may be determined for each instruction or class of instruction. Entropy data may be encoded as binary data 310, which may complicate the encoding process but reduces delays on decoding. This approach may be advantageous, particularly in examples in which code is compressed once, transmitted in compressed form to a remote memory location, and then decompressed multiple times as needed.

In some examples, encoding may use LZ coding (e.g., LZ4 coding), arithmetic coding (AC), or a combination of LZ coding and arithmetic coding at step 312. Using match searching, instructions may be encoded as tokens, such as LZ tokens (e.g., LZ4 tokens), at step 314. LZ coding and arithmetic coding may be co-optimized at step 312, for example, to minimize or at least approximately minimize the file size of the compressed code.

As shown in FIG. 3, code may be encoded (e.g., compressed), transmitted to a location, and then decoded (e.g., decompressed). Raw data 302 may include code to be compressed, such as binary code, and may include instructions (e.g., class A, class B or class C instructions). Instructions may be matched to tokens, such as LZ tokens, in particular as LZ4 tokens. Matching may use a dictionary, preceding data, and/or other matching approach. Zero segments (e.g., pieces of code with no instructions) may be identified, and in some examples may be omitted or more highly compressed in the compressed code.

At step 304, a first estimate (e.g., a rough estimate) of symbol distribution may be obtained, for example, from feature vectors obtained for each chunk. The symbol distribution may be used to implement chunk clustering at step 306, for example, based on chunk-wise statistics.

Entropy data (e.g., entropy tables 308) may be determined for the chunks and the entropy data may be coded as binary files (e.g., binary data 310). In some examples, entropy tables 308 may be based on instructions or class of instruction. In some examples, each class of instruction may have an associated entropy table.

In some examples, decoding may include using a finite state entropy (FSE) decoder 316 to recover entropy data. Instructions may be recovered from tokens by a token decoder, such as an LZ4 decoder 318. In some examples, the code reconstruction may be lossless.

In some examples, each instruction type may have an associated entropy table 308 for arithmetic coding. Approaches may include identifying the distribution and/or locality of different types of instructions. In some examples, a chunk clustering approach may include gathering feature vectors for each code chunk and applying dimensionality reduction and clustering to gather code chunks into clusters. Each cluster may have an associated symbol table 308.

In some examples, a combination of LZ4 and AC may be used for code compression. An entropy estimation may be determined for each symbol prior to the LZ4 match searching. A match representation may be selected that gives a fewest number of bits (e.g., the minimum compressed code size). Compression may be optimized instead of optimizing for the match length for each token. In some examples, an ad-hoc DSP code compression approach may include using a cost estimation function as a guidance to LZ4 match searching. By migrating run-length coding into the existing scheme, all-zero code segments may be represented with more compact forms. Dimensionality reduction and/or clustering methods may be used to exploit more redundancies among the code chunks from higher-dimensional spaces. Context-adaptive entropy coding may be used to maximize the task-specific shared information and may provide code length reduction with no information loss.

Examples further include electronic circuits for use in augmented reality and/or virtual reality (AR/VR) devices, for example, as described further below.

In some examples, code may be transmitted to a special-purpose hardware device such as a digital signal processor (DSP) or any circuit, system, subsystem and/or hardware accelerator designed to perform one or more processes. For example, in an augmented reality and/or virtual reality device (AR/VR device), processes may include one or more of signal processing, object tracking, eye tracking, computer vision acceleration, or other process. Examples may be implemented as a system on a chip (SoC) and/or as an application-specific integrated circuit (ASIC). Further example subsystems are described below. In some examples, code may be transmitted to a hardware accelerator, such as a software and/or hardware-based component that performs a process such as signal processing and/or signal analysis. For example, a computer vision accelerator may include a software and/or hardware based device that executes a positional tracking algorithm. Example hardware accelerators may provide image analysis, image processing, trainable models (e.g., a neural network), object tracking (e.g., hand or eye tracking), object identification, or other process.

As set forth above, the disclosed systems and methods may divide binary code (e.g., that includes instructions) into a plurality of chunks, cluster similar chunks, and perform compression of the binary code (e.g., using two or more different compression techniques (e.g., arithmetic coding and another lossless compression algorithm)) that is tailored to one or more clusters of the similar chunks. In this way, the disclosed systems and methods may reduce DSP footprint resulting in improved miniaturization that may be of benefit in various devices (e.g., augmented-reality glasses and/or virtual-reality headsets) in which DSPs may be included that store and execute instructions (e.g., to capture and/or display images and/or to perform eye tracking).

### EXAMPLE EMBODIMENTS

Example 1: A computer-implemented method may include dividing, by a computer processor, binary code into a plurality of chunks, wherein the binary code includes a plurality of instructions, clustering, by the computer processor, similar chunks of the plurality of chunks, and performing, by the computer processor, compression of the binary code, the compression being tailored to one or more clusters of the similar chunks.

Example 2: The computer-implemented method of Example 1, further comprising formulating, by the computer processor, a symbol table based on the plurality of instructions.

Example 3: The computer-implemented method of Examples 1 and 2, wherein the plurality of chunks includes divided instructions and the symbol table is formulated based on the divided instructions.

Example 4: The computer-implemented method of Examples 1 to 3, wherein the plurality of instructions is divided into half-bytes.

Example 5: The computer-implemented method of Examples 1 to 4, wherein the clustering is performed at least in part by determining chunk statistics for each chunk of the plurality of chunks and clustering chunks from the plurality of chunks into clusters based on the chunk statistics.

Example 6: The computer-implemented method of Examples 1 to 5, wherein the chunk statistics are based on at least one of variable length instruction formats, variable at least one of bit or byte distribution between instruction formats, one or more lossless compression algorithm matches, one or more zero segments within the binary code, or padding within the binary code.

Example 7: The computer-implemented method of Examples 1 to 6, wherein the compression is tailored to the one or more clusters at least in part by performing at least one evaluation of contributions of two or more different compression techniques in performing the compression, and iteratively tailoring the two or more different compression techniques based on the at least one evaluation.

Example 8: The computer-implemented method of Examples 1 to 7, wherein the two or more different compression techniques include a combination of a lossless compression algorithm corresponding to arithmetic coding and an additional lossless compression algorithm.

Example 9: The computer-implemented method of Examples 1 to 8, wherein the additional lossless compression algorithm corresponds to a Lempel-Ziv algorithm.

Example 10: A system comprising at least one physical processor and physical memory comprising computer-executable instructions that, when executed by the at least one physical processor, cause the at least one physical processor to divide binary code into a plurality of chunks, wherein the binary code includes a plurality of instructions, cluster similar chunks of the plurality of chunks, perform compression of the binary code, the compression being tailored to one or more clusters of the similar chunks.

Example 11: The system of Example 10, wherein the computer-executable instructions further cause the at least one physical processor to formulate a symbol table based on the plurality of instructions.

Example 12: The system of Examples 10 and 11, wherein the plurality of chunks includes divided instructions and the symbol table is formulated based on the divided instructions.

Example 13: The system of Examples 10 to 12, wherein the plurality of instructions is divided into half-bytes.

Example 14: The system of Examples 10 to 13, wherein the computer-executable instructions cause the at least one physical processor to cluster the similar chunks at least in part by determining chunk statistics for each chunk of the plurality of chunks, and clustering chunks from the plurality of chunks into clusters based on the chunk statistics.

Example 15: The system of Examples 10 to 14, wherein the compression is tailored to the one or more clusters at least in part by performing at least one evaluation of contributions of two or more different compression techniques in performing the compression, and iteratively tailoring the two or more different compression techniques based on the at least one evaluation.

Example 16: The system of Examples 10 to 15, wherein the two or more different compression techniques include a combination of a lossless compression algorithm corresponding to arithmetic coding and an additional lossless compression algorithm.

Example 17: The system of Examples 10 to 16, wherein the additional lossless compression algorithm corresponds to a Lempel-Ziv algorithm.

Example 18: A non-transitory computer-readable medium comprising one or more computer-executable instructions that, when executed by at least one processor of a computing device, cause the computing device to divide binary code into a plurality of chunks, wherein the binary code includes a plurality of instructions, cluster similar chunks of the plurality of chunks, and perform compression of the binary code, the compression being tailored to one or more clusters of the similar chunks.

Example 19: The non-transitory computer-readable medium of Example 18, wherein the one or more computer-executable instructions cause the computing device to cluster the similar chunks at least in part by determining chunk statistics for each chunk of the plurality of chunks, and clustering chunks from the plurality of chunks into clusters based on the chunk statistics.

Example 20: The non-transitory computer-readable medium of Examples 17 to 19, wherein the compression is tailored to the one or more clusters at least in part by performing at least one evaluation of contributions of two or more different compression techniques in performing the compression, wherein the two or more different compression techniques include a combination of a lossless compression algorithm corresponding to arithmetic coding and an additional lossless compression algorithm, and iteratively tailoring the two or more different compression techniques based on the at least one evaluation.

Embodiments of the present disclosure may include or be implemented in-conjunction with various types of artificial-reality systems. Artificial reality is a form of reality that has been adjusted in some manner before presentation to a user, which may include, for example, a virtual reality, an augmented reality, a mixed reality, a hybrid reality, or some combination and/or derivative thereof. Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a three-dimensional (3D) effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

Artificial-reality systems may be implemented in a variety of different form factors and configurations. Some artificial-reality systems may be designed to work without near-eye displays (NEDs). Other artificial-reality systems may include an NED that also provides visibility into the real world (such as, e.g., augmented-reality system 400 in FIG. 4) or that visually immerses a user in an artificial reality (such as, e.g., virtual-reality system 500 in FIG. 5). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 4, augmented-reality system 400 may include an eyewear device 402 with a frame 410 configured to hold a left display device 415(A) and a right display device 415(B) in front of a user's eyes. Display devices 415(A) and 415(B) may act together or independently to present an image or series of images to a user. While augmented-reality system 400 includes two displays, embodiments of this disclosure may be implemented in augmented-reality systems with a single NED or more than two NEDs.

In some embodiments, augmented-reality system 400 may include one or more sensors, such as sensor 440. Sensor 440 may generate measurement signals in response to motion of augmented-reality system 400 and may be located on substantially any portion of frame 410. Sensor 440 may represent one or more of a variety of different sensing mechanisms, such as a position sensor, an inertial measurement unit (IMU), a depth camera assembly, a structured light emitter and/or detector, or any combination thereof. In some embodiments, augmented-reality system 400 may or may not include sensor 440 or may include more than one sensor. In embodiments in which sensor 440 includes an IMU, the IMU may generate calibration data based on measurement signals from sensor 440. Examples of sensor 440 may include, without limitation, accelerometers, gyroscopes, magnetometers, other suitable types of sensors that detect motion, sensors used for error correction of the IMU, or some combination thereof.

In some examples, augmented-reality system 400 may also include a microphone array with a plurality of acoustic transducers 420(A)-420(J), referred to collectively as acoustic transducers 420. Acoustic transducers 420 may represent transducers that detect air pressure variations induced by sound waves. Each acoustic transducer 420 may be configured to detect sound and convert the detected sound into an electronic format (e.g., an analog or digital format). The microphone array in FIG. 4 may include, for example, ten acoustic transducers: 420(A) and 420(B), which may be designed to be placed inside a corresponding ear of the user, acoustic transducers 420(C), 420(D), 420(E), 420(F), 420(G), and 420(H), which may be positioned at various locations on frame 410, and/or acoustic transducers 420(I) and 420(J), which may be positioned on a corresponding neckband 405.

In some embodiments, one or more of acoustic transducers 420(A)-(J) may be used as output transducers (e.g., speakers). For example, acoustic transducers 420(A) and/or 420(B) may be earbuds or any other suitable type of headphone or speaker.

The configuration of acoustic transducers 420 of the microphone array may vary. While augmented-reality system 400 is shown in FIG. 4 as having ten acoustic transducers 420, the number of acoustic transducers 420 may be greater or less than ten. In some embodiments, using higher numbers of acoustic transducers 420 may increase the amount of audio information collected and/or the sensitivity and accuracy of the audio information. In contrast, using a lower number of acoustic transducers 420 may decrease the computing power required by an associated controller 450 to process the collected audio information. In addition, the position of each acoustic transducer 420 of the microphone array may vary. For example, the position of an acoustic transducer 420 may include a defined position on the user, a defined coordinate on frame 410, an orientation associated with each acoustic transducer 420, or some combination thereof.

Acoustic transducers 420(A) and 420(B) may be positioned on different parts of the user's ear, such as behind the pinna, behind the tragus, and/or within the auricle or fossa. Or, there may be additional acoustic transducers 420 on or surrounding the ear in addition to acoustic transducers 420 inside the ear canal. Having an acoustic transducer 420 positioned next to an ear canal of a user may enable the microphone array to collect information on how sounds arrive at the ear canal. By positioning at least two of acoustic transducers 420 on either side of a user's head (e.g., as binaural microphones), augmented-reality system 400 may simulate binaural hearing and capture a 3D stereo sound field around about a user's head. In some embodiments, acoustic transducers 420(A) and 420(B) may be connected to augmented-reality system 400 via a wired connection 430, and in other embodiments acoustic transducers 420(A) and 420(B) may be connected to augmented-reality system 400 via a wireless connection (e.g., a BLUETOOTH connection). In still other embodiments, acoustic transducers 420(A) and 420(B) may not be used at all in conjunction with augmented-reality system 400.

Acoustic transducers 420 on frame 410 may be positioned in a variety of different ways, including along the length of the temples, across the bridge, above or below display devices 415(A) and 415(B), or some combination thereof. Acoustic transducers 420 may also be oriented such that the microphone array is able to detect sounds in a wide range of directions surrounding the user wearing the augmented-reality system 400. In some embodiments, an optimization process may be performed during manufacturing of augmented-reality system 400 to determine relative positioning of each acoustic transducer 420 in the microphone array.

In some examples, augmented-reality system 400 may include or be connected to an external device (e.g., a paired device), such as neckband 405. Neckband 405 generally represents any type or form of paired device. Thus, the following discussion of neckband 405 may also apply to various other paired devices, such as charging cases, smart watches, smart phones, wrist bands, other wearable devices, hand-held controllers, tablet computers, laptop computers, other external computer devices, and the like.

As shown, neckband 405 may be coupled to eyewear device 402 via one or more connectors. The connectors may be wired or wireless and may include electrical and/or non-electrical (e.g., structural) components. In some cases, eyewear device 402 and neckband 405 may operate independently without any wired or wireless connection between them. While FIG. 4 illustrates the components of eyewear device 402 and neckband 405 in example locations on eyewear device 402 and neckband 405, the components may be located elsewhere and/or distributed differently on eyewear device 402 and/or neckband 405. In some embodiments, the components of eyewear device 402 and neckband 405 may be located on one or more additional peripheral devices paired with eyewear device 402, neckband 405, or some combination thereof.

Pairing external devices, such as neckband 405, with augmented-reality eyewear devices may enable the eyewear devices to achieve the form factor of a pair of glasses while still providing sufficient battery and computation power for expanded capabilities. Some or all of the battery power, computational resources, and/or additional features of augmented-reality system 400 may be provided by a paired device or shared between a paired device and an eyewear device, thus reducing the weight, heat profile, and form factor of the eyewear device overall while still retaining desired functionality. For example, neckband 405 may allow components that would otherwise be included on an eyewear device to be included in neckband 405 since users may tolerate a heavier weight load on their shoulders than they would tolerate on their heads. Neckband 405 may also have a larger surface area over which to diffuse and disperse heat to the ambient environment. Thus, neckband 405 may allow for greater battery and computation capacity than might otherwise have been possible on a stand-alone eyewear device. Since weight carried in neckband 405 may be less invasive to a user than weight carried in eyewear device 402, a user may tolerate wearing a lighter eyewear device and carrying or wearing the paired device for greater lengths of time than a user would tolerate wearing a heavy standalone eyewear device, thereby enabling users to more fully incorporate artificial-reality environments into their day-to-day activities.

Neckband 405 may be communicatively coupled with eyewear device 402 and/or to other devices. These other devices may provide certain functions (e.g., tracking, localizing, depth mapping, processing, storage, etc.) to augmented-reality system 400. In the embodiment of FIG. 4, neckband 405 may include two acoustic transducers (e.g., 420(I) and 420(J)) that are part of the microphone array (or potentially form their own microphone subarray). Neckband 405 may also include a controller 425 and a power source 435.

Acoustic transducers 420(I) and 420(J) of neckband 405 may be configured to detect sound and convert the detected sound into an electronic format (analog or digital). In the embodiment of FIG. 4, acoustic transducers 420(I) and 420(J) may be positioned on neckband 405, thereby increasing the distance between the neckband acoustic transducers 420(I) and 420(J) and other acoustic transducers 420 positioned on eyewear device 402. In some cases, increasing the distance between acoustic transducers 420 of the microphone array may improve the accuracy of beamforming performed via the microphone array. For example, if a sound is detected by acoustic transducers 420(C) and 420(D) and the distance between acoustic transducers 420(C) and 420(D) is greater than, e.g., the distance between acoustic transducers 420(D) and 420(E), the determined source location of the detected sound may be more accurate than if the sound had been detected by acoustic transducers 420(D) and 420(E).

Controller 425 of neckband 405 may process information generated by the sensors on neckband 405 and/or augmented-reality system 400. For example, controller 425 may process information from the microphone array that describes sounds detected by the microphone array. For each detected sound, controller 425 may perform a direction-of-arrival (DOA) estimation to estimate a direction from which the detected sound arrived at the microphone array. As the microphone array detects sounds, controller 425 may populate an audio data set with the information. In embodiments in which augmented-reality system 400 includes an inertial measurement unit, controller 425 may compute all inertial and spatial calculations from the IMU located on eyewear device 402. A connector may convey information between augmented-reality system 400 and neckband 405 and between augmented-reality system 400 and controller 425. The information may be in the form of optical data, electrical data, wireless data, or any other transmittable data form. Moving the processing of information generated by augmented-reality system 400 to neckband 405 may reduce weight and heat in eyewear device 402, making it more comfortable to the user.

Power source 435 in neckband 405 may provide power to eyewear device 402 and/or to neckband 405. Power source 435 may include, without limitation, lithium-ion batteries, lithium-polymer batteries, primary lithium batteries, alkaline batteries, or any other form of power storage. In some cases, power source 435 may be a wired power source. Including power source 435 on neckband 405 instead of on eyewear device 402 may help better distribute the weight and heat generated by power source 435.

As noted, some artificial-reality systems may, instead of blending an artificial reality with actual reality, substantially replace one or more of a user's sensory perceptions of the real world with a virtual experience. One example of this type of system is a head-worn display system, such as virtual-reality system 500 in FIG. 5, that mostly or completely covers a user's field of view. Virtual-reality system 500 may include a front rigid body 502 and a band 504 shaped to fit around a user's head. Virtual-reality system 500 may also include output audio transducers 506(A) and 506(B). Furthermore, while not shown in FIG. 5, front rigid body 502 may include one or more electronic elements, including one or more electronic displays, one or more inertial measurement units (IMUs), one or more tracking emitters or detectors, and/or any other suitable device or system for creating an artificial-reality experience.

Artificial-reality systems may include a variety of types of visual feedback mechanisms. For example, display devices in augmented-reality system 600 and/or virtual-reality system 500 may include one or more liquid crystal displays (LCDs), light emitting diode (LED) displays, microLED displays, organic LED (OLED) displays, digital light project (DLP) micro-displays, liquid crystal on silicon (LCoS) micro-displays, and/or any other suitable type of display screen. These artificial-reality systems may include a single display screen for both eyes or may provide a display screen for each eye, which may allow for additional flexibility for varifocal adjustments or for correcting a user's refractive error. Some of these artificial-reality systems may also include optical subsystems having one or more lenses (e.g., concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some of the artificial-reality systems described herein may include one or more projection systems. For example, display devices in augmented-reality system 600 and/or virtual-reality system 500 may include micro-LED projectors that project light (using, e.g., a waveguide) into display devices, such as clear combiner lenses that allow ambient light to pass through. The display devices may refract the projected light toward a user's pupil and may enable a user to simultaneously view both artificial-reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial-reality systems may also be configured with any other suitable type or form of image projection system, such as retinal projectors used in virtual retina displays.

The artificial-reality systems described herein may also include various types of computer vision components and subsystems. For example, augmented-reality system 400 and/or virtual-reality system 500 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial-reality system may process data from one or more of these sensors to identify a location of a user, to map the real world, to provide a user with context about real-world surroundings, and/or to perform a variety of other functions.

The artificial-reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

In some embodiments, the artificial-reality systems described herein may also include tactile (i.e., haptic) feedback systems, which may be incorporated into headwear, gloves, body suits, handheld controllers, environmental devices (e.g., chairs, floormats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial-reality devices, within other artificial-reality devices, and/or in conjunction with other artificial-reality devices.

By providing haptic sensations, audible content, and/or visual content, artificial-reality systems may create an entire virtual experience or enhance a user's real-world experience in a variety of contexts and environments. For instance, artificial-reality systems may assist or extend a user's perception, memory, or cognition within a particular environment. Some systems may enhance a user's interactions with other people in the real world or may enable more immersive interactions with other people in a virtual world. Artificial-reality systems may also be used for educational purposes (e.g., for teaching or training in schools, hospitals, business enterprises, other training applications, etc.), entertainment purposes (e.g., for playing video games, listening to music, watching video content, etc.), and/or for accessibility purposes (e.g., as hearing aids, visual aids, etc.). The embodiments disclosed herein may enable or enhance a user's artificial-reality experience in one or more of these contexts and environments and/or in other contexts and environments.

In some embodiments, the systems described herein may also include an eye-tracking subsystem designed to identify and track various characteristics of a user's eye(s), such as the user's gaze direction. The phrase “eye tracking” may, in some examples, refer to a process by which the position, orientation, and/or motion of an eye is measured, detected, sensed, determined, and/or monitored. The disclosed systems may measure the position, orientation, and/or motion of an eye in a variety of different ways, including through the use of various optical-based eye-tracking techniques, ultrasound-based eye-tracking techniques, etc. An eye-tracking subsystem may be configured in a number of different ways and may include a variety of different eye-tracking hardware components or other computer-vision components. For example, an eye-tracking subsystem may include a variety of different optical sensors, such as two-dimensional (2D) or 3D cameras, time-of-flight depth sensors, single-beam or sweeping laser rangefinders, 3D LiDAR sensors, and/or any other suitable type or form of optical sensor. In this example, a processing subsystem may process data from one or more of these sensors to measure, detect, determine, and/or otherwise monitor the position, orientation, and/or motion of the user's eye(s).

FIG. 6 is an illustration of an exemplary system 600 that incorporates an eye-tracking subsystem capable of tracking a user's eye(s). As depicted in FIG. 6, system 600 may include a light source 602, an optical subsystem 604, an eye-tracking subsystem 606, and/or a control subsystem 608. In some examples, light source 602 may generate light for an image (e.g., to be presented to an eye 601 of the viewer). Light source 602 may represent any of a variety of suitable devices. For example, light source 602 can include a two-dimensional projector (e.g., a LCoS display), a scanning source (e.g., a scanning laser), or other device (e.g., an LCD, an LED display, an OLED display, an active-matrix OLED display (AMOLED), a transparent OLED display (TOLED), a waveguide, or some other display capable of generating light for presenting an image to the viewer). In some examples, the image may represent a virtual image, which may refer to an optical image formed from the apparent divergence of light rays from a point in space, as opposed to an image formed from the light ray's actual divergence.

In some embodiments, optical subsystem 604 may receive the light generated by light source 602 and generate, based on the received light, converging light 620 that includes the image. In some examples, optical subsystem 604 may include any number of lenses (e.g., Fresnel lenses, convex lenses, concave lenses), apertures, filters, mirrors, prisms, and/or other optical components, possibly in combination with actuators and/or other devices. In particular, the actuators and/or other devices may translate and/or rotate one or more of the optical components to alter one or more aspects of converging light 620. Further, various mechanical couplings may serve to maintain the relative spacing and/or the orientation of the optical components in any suitable combination.

In one embodiment, eye-tracking subsystem 606 may generate tracking information indicating a gaze angle of an eye 601 of the viewer. In this embodiment, control subsystem 608 may control aspects of optical subsystem 604 (e.g., the angle of incidence of converging light 620) based at least in part on this tracking information. Additionally, in some examples, control subsystem 608 may store and utilize historical tracking information (e.g., a history of the tracking information over a given duration, such as the previous second or fraction thereof) to anticipate the gaze angle of eye 601 (e.g., an angle between the visual axis and the anatomical axis of eye 601). In some embodiments, eye-tracking subsystem 606 may detect radiation emanating from some portion of eye 601 (e.g., the cornea, the iris, the pupil, or the like) to determine the current gaze angle of eye 601. In other examples, eye-tracking subsystem 606 may employ a wavefront sensor to track the current location of the pupil.

Any number of techniques can be used to track eye 601. Some techniques may involve illuminating eye 601 with infrared light and measuring reflections with at least one optical sensor that is tuned to be sensitive to the infrared light. Information about how the infrared light is reflected from eye 601 may be analyzed to determine the position(s), orientation(s), and/or motion(s) of one or more eye feature(s), such as the cornea, pupil, iris, and/or retinal blood vessels.

In some examples, the radiation captured by a sensor of eye-tracking subsystem 606 may be digitized (i.e., converted to an electronic signal). Further, the sensor may transmit a digital representation of this electronic signal to one or more processors (for example, processors associated with a device including eye-tracking subsystem 606). Eye-tracking subsystem 606 may include any of a variety of sensors in a variety of different configurations. For example, eye-tracking subsystem 606 may include an infrared detector that reacts to infrared radiation. The infrared detector may be a thermal detector, a photonic detector, and/or any other suitable type of detector. Thermal detectors may include detectors that react to thermal effects of the incident infrared radiation.

In some examples, one or more processors may process the digital representation generated by the sensor(s) of eye-tracking subsystem 606 to track the movement of eye 601. In another example, these processors may track the movements of eye 601 by executing algorithms represented by computer-executable instructions stored on non-transitory memory. In some examples, on-chip logic (e.g., an application-specific integrated circuit or ASIC) may be used to perform at least portions of such algorithms. As noted, eye-tracking subsystem 606 may be programmed to use an output of the sensor(s) to track movement of eye 601. In some embodiments, eye-tracking subsystem 606 may analyze the digital representation generated by the sensors to extract eye rotation information from changes in reflections. In one embodiment, eye-tracking subsystem 606 may use corneal reflections or glints (also known as Purkinje images) and/or the center of the eye's pupil 622 as features to track over time.

In some embodiments, eye-tracking subsystem 606 may use the center of the eye's pupil 622 and infrared or near-infrared, non-collimated light to create corneal reflections. In these embodiments, eye-tracking subsystem 606 may use the vector between the center of the eye's pupil 622 and the corneal reflections to compute the gaze direction of eye 601. In some embodiments, the disclosed systems may perform a calibration procedure for an individual (using, e.g., supervised or unsupervised techniques) before tracking the user's eyes. For example, the calibration procedure may include directing users to look at one or more points displayed on a display while the eye-tracking system records the values that correspond to each gaze position associated with each point.

In some embodiments, eye-tracking subsystem 606 may use two types of infrared and/or near-infrared (also known as active light) eye-tracking techniques: bright-pupil and dark-pupil eye tracking, which may be differentiated based on the location of an illumination source with respect to the optical elements used. If the illumination is coaxial with the optical path, then eye 601 may act as a retroreflector as the light reflects off the retina, thereby creating a bright pupil effect similar to a red-eye effect in photography. If the illumination source is offset from the optical path, then the eye's pupil 622 may appear dark because the retroreflection from the retina is directed away from the sensor. In some embodiments, bright-pupil tracking may create greater iris/pupil contrast, allowing more robust eye tracking with iris pigmentation, and may feature reduced interference (e.g., interference caused by eyelashes and other obscuring features). Bright-pupil tracking may also allow tracking in lighting conditions ranging from total darkness to a very bright environment.

In some embodiments, control subsystem 608 may control light source 602 and/or optical subsystem 604 to reduce optical aberrations (e.g., chromatic aberrations and/or monochromatic aberrations) of the image that may be caused by or influenced by eye 601. In some examples, as mentioned above, control subsystem 608 may use the tracking information from eye-tracking subsystem 606 to perform such control. For example, in controlling light source 602, control subsystem 608 may alter the light generated by light source 602 (e.g., by way of image rendering) to modify (e.g., pre-distort) the image so that the aberration of the image caused by eye 601 is reduced.

The disclosed systems may track both the position and relative size of the pupil (since, e.g., the pupil dilates and/or contracts). In some examples, the eye-tracking devices and components (e.g., sensors and/or sources) used for detecting and/or tracking the pupil may be different (or calibrated differently) for different types of eyes. For example, the frequency range of the sensors may be different (or separately calibrated) for eyes of different colors and/or different pupil types, sizes, and/or the like. As such, the various eye-tracking components (e.g., infrared sources and/or sensors) described herein may need to be calibrated for each individual user and/or eye.

The disclosed systems may track both eyes with and without ophthalmic correction, such as that provided by contact lenses worn by the user. In some embodiments, ophthalmic correction elements (e.g., adjustable lenses) may be directly incorporated into the artificial reality systems described herein. In some examples, the color of the user's eye may necessitate modification of a corresponding eye-tracking algorithm. For example, eye-tracking algorithms may need to be modified based at least in part on the differing color contrast between a brown eye and, for example, a blue eye.

FIG. 7 is a more detailed illustration of various aspects of the eye-tracking subsystem illustrated in FIG. 6. As shown in this figure, an eye-tracking subsystem 700 may include at least one source 704 and at least one sensor 706. Source 704 generally represents any type or form of element capable of emitting radiation. In one example, source 704 may generate visible, infrared, and/or near-infrared radiation. In some examples, source 704 may radiate non-collimated infrared and/or near-infrared portions of the electromagnetic spectrum towards an eye 702 of a user. Source 704 may utilize a variety of sampling rates and speeds. For example, the disclosed systems may use sources with higher sampling rates in order to capture fixational eye movements of a user's eye 702 and/or to correctly measure saccade dynamics of the user's eye 702. As noted above, any type or form of eye-tracking technique may be used to track the user's eye 702, including optical-based eye-tracking techniques, ultrasound-based eye-tracking techniques, etc.

Sensor 706 generally represents any type or form of element capable of detecting radiation, such as radiation reflected off the user's eye 702. Examples of sensor 706 include, without limitation, a charge coupled device (CCD), a photodiode array, a complementary metal-oxide-semiconductor (CMOS) based sensor device, and/or the like. In one example, sensor 706 may represent a sensor having predetermined parameters, including, but not limited to, a dynamic resolution range, linearity, and/or other characteristic selected and/or designed specifically for eye tracking.

As detailed above, eye-tracking subsystem 700 may generate one or more glints. As detailed above, a glint 703 may represent reflections of radiation (e.g., infrared radiation from an infrared source, such as source 704) from the structure of the user's eye. In various embodiments, glint 703 and/or the user's pupil may be tracked using an eye-tracking algorithm executed by a processor (either within or external to an artificial reality device). For example, an artificial reality device may include a processor and/or a memory device in order to perform eye tracking locally and/or a transceiver to send and receive the data necessary to perform eye tracking on an external device (e.g., a mobile phone, cloud server, or other computing device).

FIG. 7 shows an example image 705 captured by an eye-tracking subsystem, such as eye-tracking subsystem 700. In this example, image 705 may include both the user's pupil 708 and a glint 710 near the same. In some examples, pupil 708 and/or glint 710 may be identified using an artificial-intelligence-based algorithm, such as a computer-vision-based algorithm. In one embodiment, image 705 may represent a single frame in a series of frames that may be analyzed continuously in order to track the eye 702 of the user. Further, pupil 708 and/or glint 710 may be tracked over a period of time to determine a user's gaze.

In one example, eye-tracking subsystem 700 may be configured to identify and measure the inter-pupillary distance (IPD) of a user. In some embodiments, eye-tracking subsystem 700 may measure and/or calculate the IPD of the user while the user is wearing the artificial reality system. In these embodiments, eye-tracking subsystem 700 may detect the positions of a user's eyes and may use this information to calculate the user's IPD.

As noted, the eye-tracking systems or subsystems disclosed herein may track a user's eye position and/or eye movement in a variety of ways. In one example, one or more light sources and/or optical sensors may capture an image of the user's eyes. The eye-tracking subsystem may then use the captured information to determine the user's inter-pupillary distance, interocular distance, and/or a 3D position of each eye (e.g., for distortion adjustment purposes), including a magnitude of torsion and rotation (i.e., roll, pitch, and yaw) and/or gaze directions for each eye. In one example, infrared light may be emitted by the eye-tracking subsystem and reflected from each eye. The reflected light may be received or detected by an optical sensor and analyzed to extract eye rotation data from changes in the infrared light reflected by each eye.

The eye-tracking subsystem may use any of a variety of different methods to track the eyes of a user. For example, a light source (e.g., infrared light-emitting diodes) may emit a dot pattern onto each eye of the user. The eye-tracking subsystem may then detect (e.g., via an optical sensor coupled to the artificial reality system) and analyze a reflection of the dot pattern from each eye of the user to identify a location of each pupil of the user. Accordingly, the eye-tracking subsystem may track up to six degrees of freedom of each eye (i.e., 3D position, roll, pitch, and yaw) and at least a subset of the tracked quantities may be combined from two eyes of a user to estimate a gaze point (i.e., a 3D location or position in a virtual scene where the user is looking) and/or an IPD.

In some cases, the distance between a user's pupil and a display may change as the user's eye moves to look in different directions. The varying distance between a pupil and a display as viewing direction changes may be referred to as “pupil swim” and may contribute to distortion perceived by the user as a result of light focusing in different locations as the distance between the pupil and the display changes. Accordingly, measuring distortion at different eye positions and pupil distances relative to displays and generating distortion corrections for different positions and distances may allow mitigation of distortion caused by pupil swim by tracking the 3D position of a user's eyes and applying a distortion correction corresponding to the 3D position of each of the user's eyes at a given point in time. Determining the position of each eye of a user may allow the mitigation of distortion caused by changes in the distance between the pupil of the eye and the display by applying a distortion correction for each eye based on the eye position. The position of each eye may also enable an eye-tracking subsystem to make automated adjustments for a user's interpupillary distance.

In some embodiments, a display subsystem may include a variety of additional subsystems that may work in conjunction with the eye-tracking subsystems described herein. For example, a display subsystem may include a varifocal subsystem, a scene-rendering module, and/or a vergence-processing module. The varifocal subsystem may cause left and right display elements to vary the focal distance of the display device. In one embodiment, the varifocal subsystem may physically change the distance between a display and the optics through which it is viewed by moving the display, the optics, or both. Additionally, moving or translating two lenses relative to each other may also be used to change the focal distance of the display. Thus, the varifocal subsystem may include actuators or motors that move displays and/or optics to change the distance between them. This varifocal subsystem may be separate from or integrated into the display subsystem. The varifocal subsystem may also be integrated into or separate from its actuation subsystem and/or the eye-tracking subsystems described herein.

In one example, the display subsystem may include a vergence-processing module configured to determine a vergence depth of a user's gaze based on a gaze point and/or an estimated intersection of the gaze lines determined by the eye-tracking subsystem. Vergence may refer to the simultaneous movement or rotation of both eyes in opposite directions to maintain single binocular vision, which may be naturally and automatically performed by the human eye. Thus, a location where a user's eyes are verged is where the user is looking and is also typically the location where the user's eyes are focused. For example, the vergence-processing module may triangulate gaze lines to estimate a distance or depth from the user associated with intersection of the gaze lines. The depth associated with intersection of the gaze lines may then be used as an approximation for the accommodation distance, which may identify a distance from the user where the user's eyes are directed. Thus, the vergence distance may allow for the determination of a location where the user's eyes should be focused and a depth from the user's eyes at which the eyes are focused, thereby providing information (such as an object or plane of focus) for rendering adjustments to the virtual scene.

The vergence-processing module may coordinate with the eye-tracking subsystems described herein to make adjustments to the display subsystem to account for a user's vergence depth. When the user is focused on something at a distance, the user's pupils may be slightly farther apart than when the user is focused on something close. The eye-tracking subsystem may obtain information about the user's vergence or focus depth and may adjust the display subsystem to be closer together when the user's eyes focus or verge on something close and to be farther apart when the user's eyes focus or verge on something at a distance.

The eye-tracking information generated by the above-described eye-tracking subsystems may also be used, for example, to modify various aspect of how different computer-generated images are presented. For example, a display subsystem may be configured to modify, based on information generated by an eye-tracking subsystem, at least one aspect of how the computer-generated images are presented. For instance, the computer-generated images may be modified based on the user's eye movement, such that if a user is looking up, the computer-generated images may be moved upward on the screen. Similarly, if the user is looking to the side or down, the computer-generated images may be moved to the side or downward on the screen. If the user's eyes are closed, the computer-generated images may be paused or removed from the display and resumed once the user's eyes are back open.

The above-described eye-tracking subsystems can be incorporated into one or more of the various artificial reality systems described herein in a variety of ways. In some examples, subsystems may be implemented using one or more digital signal processors configured to receive compressed code from a processor. For example, one or more of the various components of system 600 and/or eye-tracking subsystem 700 may be incorporated into augmented-reality system 400 in FIG. 4 and/or virtual-reality system 500 in FIG. 5 to enable these systems to perform various eye-tracking tasks (including one or more of the eye-tracking operations described herein).

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. For example, one or more of the modules recited herein may receive raw data (e.g., including coded instructions) to be transformed, transform the raw data, output a result of the transformation to provide clustered chunks, use the result of the transformation to compress the data, and store the result of the transformation in a memory for use by a digital signal processor in decompressing and executing the coded instructions. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computer-implemented method comprising:
dividing, by a computer processor, binary code into a plurality of chunks, wherein the binary code includes a plurality of instructions;
clustering, by the computer processor, similar chunks of the plurality of chunks; and
performing, by the computer processor, compression of the binary code, the compression being tailored to one or more clusters of the similar chunks.

2. The computer-implemented method of claim 1, further comprising:
formulating, by the computer processor, a symbol table based on the plurality of instructions.

3. The computer-implemented method of claim 2, wherein the plurality of chunks includes divided instructions and the symbol table is formulated based on the divided instructions.

4. The computer-implemented method of claim 3, wherein the plurality of instructions is divided into half-bytes.

5. The computer-implemented method of claim 1, wherein the clustering is performed at least in part by:
determining chunk statistics for each chunk of the plurality of chunks; and
clustering chunks from the plurality of chunks into clusters based on the chunk statistics.

6. The computer-implemented method of claim 5, wherein the chunk statistics are based on at least one of:
variable length instruction formats;
variable at least one of bit or byte distribution between instruction formats;
one or more lossless compression algorithm matches;
one or more zero segments within the binary code; or
padding within the binary code.

7. The computer-implemented method of claim 1, wherein the compression is tailored to the one or more clusters at least in part by:
performing at least one evaluation of contributions of two or more different compression techniques in performing the compression; and
iteratively tailoring the two or more different compression techniques based on the at least one evaluation.

8. The computer-implemented method of claim 7, wherein the two or more different compression techniques include a combination of a lossless compression algorithm corresponding to arithmetic coding and an additional lossless compression algorithm.

9. The computer-implemented method of claim 8, wherein the additional lossless compression algorithm corresponds to a Lempel-Ziv algorithm.

10. A system comprising:
at least one physical processor; and
physical memory comprising computer-executable instructions that, when executed by the at least one physical processor, cause the at least one physical processor to:
divide binary code into a plurality of chunks, wherein the binary code includes a plurality of instructions;
cluster similar chunks of the plurality of chunks; and
perform compression of the binary code, the compression being tailored to one or more clusters of the similar chunks.

11. The system of claim 10, wherein the computer-executable instructions further cause the at least one physical processor to:
formulate a symbol table based on the plurality of instructions.

12. The system of claim 11, wherein the plurality of chunks includes divided instructions and the symbol table is formulated based on the divided instructions.

13. The system of claim 12, wherein the plurality of instructions is divided into half-bytes.

14. The system of claim 10, wherein the computer-executable instructions cause the at least one physical processor to cluster the similar chunks at least in part by:
determining chunk statistics for each chunk of the plurality of chunks; and
clustering chunks from the plurality of chunks into clusters based on the chunk statistics.

15. The system of claim 10, wherein the compression is tailored to the one or more clusters at least in part by:
performing at least one evaluation of contributions of two or more different compression techniques in performing the compression; and
iteratively tailoring the two or more different compression techniques based on the at least one evaluation.

16. The system of claim 15, wherein the two or more different compression techniques include a combination of a lossless compression algorithm corresponding to arithmetic coding and an additional lossless compression algorithm.

17. The system of claim 16, wherein the additional lossless compression algorithm corresponds to a Lempel-Ziv algorithm.

18. A non-transitory computer-readable medium comprising one or more computer-executable instructions that, when executed by at least one processor of a computing device, cause the computing device to:
divide binary code into a plurality of chunks, wherein the binary code includes a plurality of instructions;
cluster similar chunks of the plurality of chunks; and
perform compression of the binary code, the compression being tailored to one or more clusters of the similar chunks.

19. The non-transitory computer-readable medium of claim 17, wherein the one or more computer-executable instructions cause the computing device to cluster the similar chunks at least in part by:
determining chunk statistics for each chunk of the plurality of chunks; and
clustering chunks from the plurality of chunks into clusters based on the chunk statistics.

20. The non-transitory computer-readable medium of claim 19, wherein the compression is tailored to the one or more clusters at least in part by:
performing at least one evaluation of contributions of two or more different compression techniques in performing the compression, wherein the two or more different compression techniques include a combination of a lossless compression algorithm corresponding to arithmetic coding and an additional lossless compression algorithm; and
iteratively tailoring the two or more different compression techniques based on the at least one evaluation.
